(19) United States
(12) Patent Application Publication
(10) Pub. No.: US 2008/0073522 A1
(43) Pub. Date: Mar. 27, 2008

(54) Method of correcting opaque defect of chrome mask, in which atomic force microscope fine working apparatus has been used

(76) Inventor: Osamu Takaoka, Chiba-shi (JP)

Correspondence Address: BRINKS HOFER GILSON & LIONE, P.O. BOX 10395, CHICAGO, IL, 60610, US

(21) Appl. No.: 11/725,277

(22) Filed: Mar. 19, 2007

(30) Foreign Application Priority Data
Mar. 20, 2006 (JP) JP2006-076469

(51) Int. Cl. G01N 23/00

(52) U.S. Cl. 250/306; 430/5; 250/492.21

(57) ABSTRACT

By mechanically removing a boundary portion between an opaque defect and a normal pattern in an atomic force microscope fine working apparatus having a probe harder than a worked material, or removing it in a focused ion beam fine working apparatus or an electron beam fine working apparatus, the opaque defect is isolated, and the isolated opaque defect is removed by being peeled off by a dynamic force from a glass interface whose adhesion force is weak by pushing the probe from a lateral.

This application claims priority under 35 U.S.C. §119 to Japanese Patent Application No. JP2006-076469 filed Mar. 20, 2006, the entire content of which is hereby incorporated by reference

### BACKGROUND OF THE INVENTION

The present invention relates to a method of correcting an opaque defect of a chrome mask, in which an atomic force microscope technique has been applied.

With respect to a demand for fining a semiconductor integrated circuit, a lithography has corresponded by shortening a wavelength and increasing an NA of the wavelength of a light source of a reduction projection exposure device. An opaque defect correction of a photomask, in which there is demanded the fact that there is no defect in an original form of a transcription in the reduction projection exposure device, has been hitherto performed by using a laser or a focused ion beam. However, in the laser, a resolving power is insufficient and thus the opaque defect of a fine pattern in a most tip cannot be corrected and, in the focused ion beam (FIB), by the fact that the wave length of the light source in the reduction projection exposure device is shortened, an imaging damage (reduction in transmittance) of a glass part due to an implantation of gallium used as a primary beam becomes a problem, so that there is requested a technique for correcting the opaque defect, which can correct the opaque defect of a fine pattern and in which there is no imaging damage. By introducing a gas-assisted etching, an improvement in the transmittance is contrived. However, in the chrome mask in which there exists no assisting gas capable of worming at a high etch rate, although the transmittance is improved by the gas-assisted etching, a decrease in the transmittance in a place in which the opaque defect is corrected becomes a problem. That is, in comparison with a case where there is etched a matter in which there exists the assisting gas capable of worming at the high etch rate, in a case where the opaque defect comprising a chrome is removed, it follows that there is increased an implantation quantity of Ga due to the fact that a number of times in irradiation of the FIB is increased or an acceleration voltage is raised, so that a degree of the decrease in the transmittance in the place in which the opaque defect is corrected becomes large.

In response to such a request as mentioned above, recently, with respect to the opaque defect of the photomask, there becomes such that there is applied an atomic force microscope scratch working in which the opaque defect is physically removed by a probe harder than a worked material (defect) by using an atomic force microscope (AFM) in which, in a contact mode of a low load or an intermittent contact mode, there is no imaging damage, and which has a high resolving power and a high position controllability (see, for example, Y. Morikawa, H. Kokubo, M. Nishiguchi, N. Hayashi, R. White, R. Bozak, and L. Terrill, Proc. of SPIE 5130 520-527 (2003)). In the atomic force microscope scratch working, although the transmittance after the correction is high, a throughput of the working is low, so that it is requested to increase the throughput of the working.

Even by the atomic force microscope scratch working, with respect to a small isolated defect, since the working can be performed by cleanly peeling off a chrome film by a dynamic force by pushing the probe from a lateral, it is possible to perform the working of a comparatively high throughput. However, in a case of the opaque defect, which contacts with a normal pattern, like a protrusion defect, a bridge defect or a corner defect, a time has been taken for the working.

An object of the present invention is to provide a correction technique in which there has coexisted a high transmittance of the opaque defect of the chrome mask and a high throughput.

### SUMMARY OF THE INVENTION

In order to solve the above problems, in the method of correcting the opaque defect of the chrome mask in the invention of the present application, if a chrome film is not so strong in its adhesion force with a glass interface and its isolated defect is small, there is utilized a nature that the chrome film can be peeled off by a dynamic force without a damage, such as hollow, in a substrate glass face by pushing the probe from the lateral. That is, there is characterized in that an isolated opaque defect is removed by being peeled off from the glass interface by pushing the probe of an atomic force microscope fine working apparatus against it from the lateral.

In order to isolate the opaque defect, a boundary portion between the opaque defect and a normal pattern is mechanically removed, in the atomic force microscope fine working apparatus having the probe harder than a worked material, by a cutting with that probe.

Or, a removal of the boundary portion between the opaque defect and the normal pattern is performed by an etching by a focused ion beam fine working apparatus or an electron beam fine working apparatus.

In a case where a size of the opaque defect to be corrected is large, in addition to the boundary between the opaque defect and the normal pattern, after also the large opaque defect is divided to a size capable of being removed by being peeled off from the glass interface by pushing the probe from the lateral in the atomic force microscope fine working apparatus or the focused ion beam fine working apparatus or the electron beam fine working apparatus, there is removed by being peeled off by a dynamic force from the glass interface whose adhesion force is weak by pushing the probe of the atomic force microscope fine working apparatus from the lateral.

Since the whole or most of the removal is performed by an atomic force microscope function, there is no implantation of gallium like a time at which the opaque defect has been corrected by the focused ion beam fine working apparatus, so that it is possible to perform an opaque defect correction of the chrome mask of the high transmittance.

Further, since the isolated opaque defect is not scraped off by a scratch working of the atomic force microscope but removed by being peeled off by the dynamic force from the glass interface by utilizing a weakness of the adhesion force of the chrome film to a glass face, the working can be performed at the high throughput in comparison with a case where the working is normally performed by the scratch working of the atomic force microscope.

### BRIEF DESCRIPTION OF THE DRAWINGS

FIGS. 1A, 1B and 1C are schematic sectional views explaining a method of correcting a chrome mask, in which a boundary portion between an opaque defect and a normal pattern is removed in an atomic force microscope fine working apparatus, and an isolated opaque defect is removed by being peeled off by a dynamic force by pushing a probe from a lateral.

FIGS. 2A, 2B and 2C are schematic sectional views explaining a method of correcting the chrome mask, in which the boundary portion between the opaque defect and the normal pattern is removed in a focused ion beam fine working apparatus, and the isolated opaque defect is removed by being peeled off by the dynamic force by pushing the probe of the atomic force microscope fine working apparatus from the lateral.

FIGS. 3A, 3B and 3C are schematic sectional views explaining a method of correcting the chrome mask, in which the boundary portion between the opaque defect and the normal pattern is removed in an electron beam fine working apparatus, and the isolated opaque defect is removed by being peeled off by the dynamic force by pushing the probe of the atomic force microscope fine working apparatus from the lateral.

FIGS. 4A and 4B are schematic sectional views explaining a case where, when a size of the opaque defect to be corrected is large, the opaque defect is divided to a size capable of being removed by being peeled off.

### DETAILED DESCRIPTION OF THE PREFERRED EMBODIMENT

Hereunder, embodiments of the present invention are detailedly explained by using the drawings.

A chrome mask whose opaque defect has been found by a defect inspection apparatus is introduced to an atomic force microscope fine working apparatus, and a high accuracy XY stage is moved to a position in which the opaque defect has been found. After there has been performed an imaging of a region including the opaque defect by a contact mode or an intermittent contact mode of the atomic force microscope, a defect portion is extracted and recognized by comparing a pattern of the region including the opaque defect with a normal pattern corresponding to the former pattern, a pattern matching, and the like.

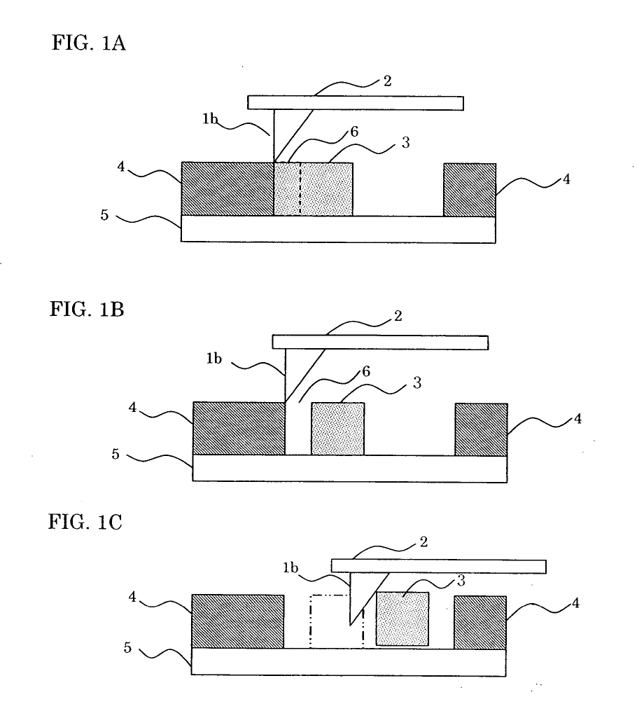

FIGS. 1A, 1B and 1C are schematic sectional views explaining a method of correcting the chrome mask, in which a boundary portion between the opaque defect and the normal pattern is removed in the atomic force microscope fine working apparatus, and an isolated opaque defect is removed by being peeled off by the dynamic force by pushing the probe from the lateral.

As shown in FIG. 1A, first, a boundary portion 6 between an opaque defect 3 and a normal pattern 4 on a glass substrate 5 is mechanically removed in the atomic force microscope fine working apparatus having a working probe 1a made of diamond for instance which is harder than a worked material, thereby isolating the opaque defect 3 as shown in FIG. 1B. The working probe 1a is provided at the end of the cantilever 2. At this time, as to the working probe, there is used one of an asymmetric shape, whose working knife point has a vertical edge or face to the glass substrate 5, and the working is performed by directing the knife edge of the asymmetric shape to such a direction that a side wall angle of the normal pattern after the working stands. Subsequently, as shown in FIG. 1C, the isolated opaque defect 3 is removed by being peeled off by the dynamic force from a substrate glass interface 5 whose adhesion force is weak by pushing the working probe 1b from the lateral under a state that its height has been fixed. After a correction completion, a worked scrap generated by the working in the atomic force microscope fine working apparatus is removed by a wet washing or a dry washing having used a fine particle dry ice irradiation.

Or, the imaging of the region including the opaque defect and a separation of the opaque defect from the normal pattern are performed by using the focused ion beam. That is, first, the chrome mask whose opaque defect has been found by the defect inspection apparatus is introduced to a focused ion beam fine working apparatus, and the high accuracy XY stage is moved to the place in which the opaque defect has been found. Next, the imaging of the region including the opaque defect is performed in the focused ion beam fine working apparatus and, by comparing it with the normal pattern, the pattern matching, and the like, the defect portion is extracted and recognized.

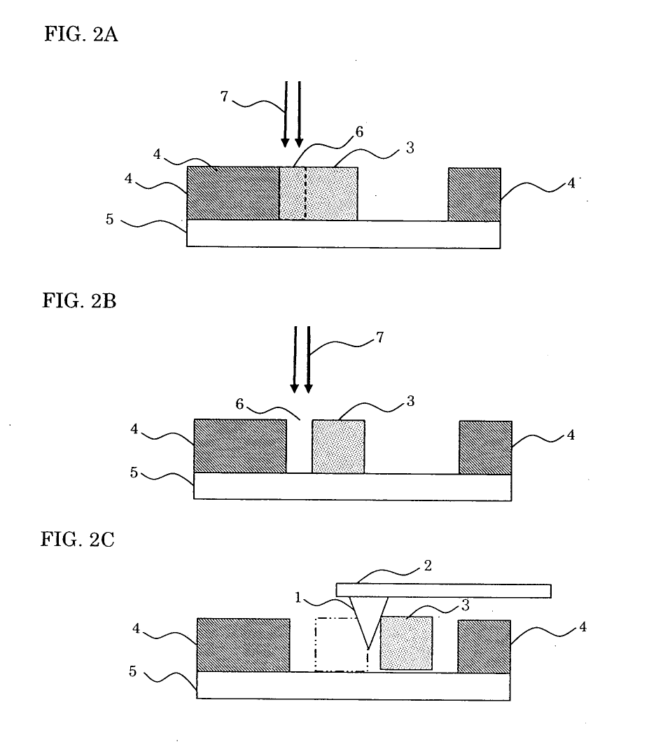

FIGS. 2A, 2B and 2C are schematic sectional views explaining a method of correcting the chrome mask, in which the boundary portion between the opaque defect and the normal pattern is removed by a focused ion beam fine working apparatus, and the isolated opaque defect is removed by being pull-peeled off by the dynamic force by pushing the probe of the atomic force microscope fine working apparatus from the lateral.

As shown in FIG. 2A, in order to remove the boundary portion 6 between the opaque defect 3 and the normal pattern 4, a focused ion beam 7 is irradiation-scanned while blowing an etching gas to the boundary portion 6. If the opaque defect has been isolated as shown in FIG. 2B, subsequently the chrome mask is taken out of the focused ion beam fine working apparatus and moved to the atomic force microscope fine working apparatus and, by moving the high accuracy XY stage, the position in which the opaque defect 3 has been found is brought below the probe 1. Next, as shown in FIG. 2C, the isolated opaque defect 3 is removed by being peeled off by the dynamic force from the substrate glass interface 5 whose adhesion force is weak by pushing the working probe 1 of the atomic force microscope fine working apparatus from the lateral under the state that its height has been fixed. The worked scrap having been removed is taken away by the wet washing or the dry washing having used the fine particle dry ice irradiation.

Or, the imaging of the region including the opaque defect and the separation of the opaque defect from the normal pattern are performed by using an electron beam. That is, or, the chrome mask whose opaque defect has been found by the defect inspection apparatus is first introduced to an electron beam fine working apparatus, and the high accuracy XY stage is moved such that the place in which the opaque defect has been found becomes a visual field. By performing the imaging of the region including the opaque defect in the electron beam fine working apparatus and comparing it with the normal pattern, the pattern matching, and the like, the defect portion is extracted and recognized.

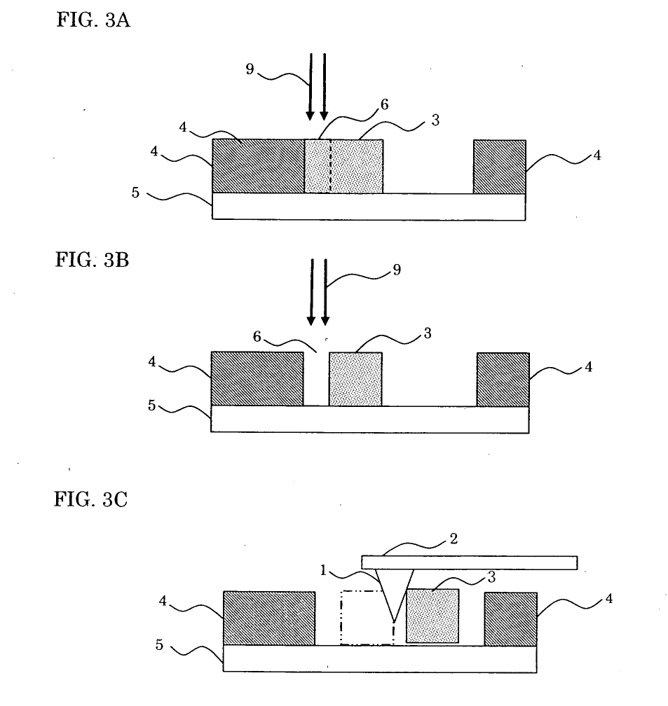

FIG. 3 is a schematic sectional view explaining a method of correcting the chrome mask, in which the boundary portion between the opaque defect and the normal pattern is removed in the electron beam fine working apparatus, and the isolated opaque defect is removed by being peeled off by the dynamic force by pushing the probe of the atomic force microscope fine working apparatus from the lateral.

As shown in FIG. 3A, in order to remove the boundary portion 6 between the opaque defect 3 and the normal pattern 4, an electron beam 9 is irradiated and scanned while blowing the etching gas to the boundary portion 6. If the opaque defect has been isolated as shown in FIG. 3B, subsequently the chrome mask is taken out and moved to the atomic force microscope fine working apparatus, and the high accuracy XY stage is moved such that the position in which the opaque defect 3 has been found becomes the visual field. As shown in FIG. 3C, the isolated opaque defect 3 is removed by being peeled off by the dynamic force from the interface between the opaque defect 3 and the glass substrate where adhesion force is weak by pushing the working probe 1 of the atomic force microscope fine working apparatus from the lateral under the state that the height of the working probe 1 has been fixed. The worked scrap having been removed is taken away by the wet washing or the dry washing having used the fine particle dry ice irradiation.

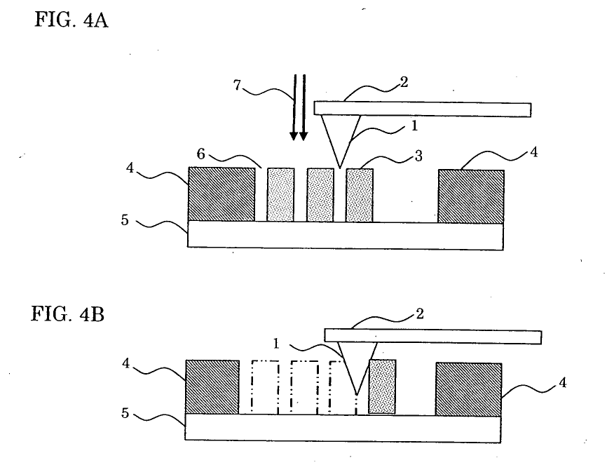

FIG. 4A and FIG. 4B are schematic sectional views explaining a case where, when a size of the opaque defect to be corrected is large, the opaque defect is divided to a size capable of being removed by being peeled off by the probe.

In the case where the size of the opaque defect to be corrected is large, in addition to the boundary 6 between the opaque defect 3 and the normal pattern 4, as shown in FIG. 4A, after also the large opaque defect itself has been divided to the size capable of being removed by being peeled off the glass substrate by pushing the probe 1 from the lateral by using the atomic force microscope fine working apparatus or the focused ion beam fine working apparatus or the electron beam fine working apparatus, subsequently as shown in FIG. 4B it is removed by being peeled off the glass substrate 5 by the dynamic force from the interface between the glass substrate 5 and whose adhesion force is weak by pushing the working probe 1 of the atomic force microscope fine working apparatus from the lateral under the state that its height has been fixed. Also in this case, the worked scrap having been removed is taken away by the wet washing or the dry washing having used the fine particle dry ice irradiation.

As mentioned above, in the present invention, since the whole or most of the removal is performed by the atomic force microscope function, it is possible to nullify or greatly reduce the implantation of gallium like the time at which all the black defect has been corrected by the focused ion beam fine working apparatus, and the correction of the opaque defect of the chrome mask of the high transmittance can be performed. Further, since the isolated opaque defect is not scraped off by the scratch working of the atomic force microscope but removed by being peeled off the glass substrate 5 by the dynamic force from the interface between glass substrate 5 and the opaque defect 3 by utilizing the weakness of the adhesion force of the chrome film to the glass face, the working can be performed at the high throughput in comparison with a case where all the opaque defect is removed by the scratch working of the atomic force microscope. Further, when working the boundary between the normal pattern and the opaque defect, since also an atomic force microscope fine working and also a focused ion beam fine working have a high working accuracy, a highly accurate defect correction is possible.

Further, in the case where the boundary between the normal pattern and the opaque defect is worked by using the focused ion beam fine working apparatus or the electron beam fine working apparatus, in the working (peeling the opaque defect 3 off the glass substrate 5 by the dynamic force from the interface between the glass substrate 5 and the black defect 3 where adhesion force is weak) of the isolated opaque defect after the working which has used the atomic force microscope fine working apparatus, it can be performed by a symmetrical shape probe having no direction dependency, so that it becomes unnecessary to use the asymmetrical shape probe whose knife edge angle for producing a side wall angle of the pattern after the working has stood. Therefor, there becomes such that it is unnecessary to perform a probe exchange to the asymmetrical shape probe or a troublesome angle alignment between a direction of the knife edge and a pattern side wall, which follows upon the asymmetrical shape probe.

What is claimed is:

1. A method of correcting an opaque defect of a chrome mask, wherein the opaque defect is removed by being peeled off a glass substrate by pushing a probe of an atomic force microscope fine working apparatus against a side face of an isolated opaque defect from a lateral.

2. A method of correcting an opaque defect of a chrome mask according to claim 1, wherein the isolated opaque defect is one having been isolated by removing a boundary between the opaque defect and a normal pattern by the atomic force microscope fine working apparatus.

3. A method of correcting an opaque defect of a chrome mask according to claim 1, wherein the isolated opaque defect is one having been isolated by removing a boundary between the opaque defect and a normal pattern by a focused ion beam fine working apparatus.

4. A method of correcting an opaque defect of a chrome mask according to claim 1, wherein the isolated opaque defect is one having been isolated by removing a boundary between the opaque defect and a normal pattern by an electron beam fine working apparatus.

5. A method of correcting an opaque defect of a chrome mask according to claim 1, wherein, in a case where a size of the isolated opaque defect is large, the opaque defect is divided to a size capable of being removed by being peeled off the glass substrate from the interface between the glass substrate and the opaque defect by pushing the probe against the side face of the opaque defect from the lateral.

6. A method of correcting an opaque defect of a chrome mask according to claim 2, wherein, in a case where a size of the isolated opaque defect is large, the opaque defect is divided to a size capable of being removed by being peeled off the glass substrate from the interface between the glass substrate and the opaque defect by pushing the probe from the lateral in the atomic force microscope fine working apparatus.

7. A method of correcting an opaque defect of a chrome mask according to claim 3, wherein, in a case where a size of the isolated opaque defect is large, the opaque defect is divided to a size capable of being removed by being peeled off the glass substrate from the interface between the glass substrate and the opaque defect by pushing the probe from the lateral in the focused ion beam fine working apparatus.

8. A method of correcting an opaque defect of a chrome mask according to claim 4, wherein, in a case where a size of the isolated opaque defect is large, the opaque defect is divided to a size capable of being removed by being peeled off the glass substrate from the interface between the glass substrate and the opaque defect by pushing the probe from the lateral in the electron beam fine working apparatus.
